(19) United States
(12) Patent Application Publication
(10) Pub. No.: US 2026/0161792 A1
(43) Pub. Date: Jun. 11, 2026

(54) DYNAMICALLY ANALYZING NATIVE APPLICATIONS USING SECURITY PROFILES

(71) Applicant: Snowflake Inc., Bozeman, MT (US)

(72) Inventors: Rishabh Gupta, San Francisco, CA (US); Hrushikesh Shrinivas Paralikar, Hayward, CA (US); Naga Krishna Vadlamudi, Puyallup, WA (US)

(21) Appl. No.: 18/972,407

(22) Filed: Dec. 6, 2024

(51) Int. Cl. G06F 21/57; G06F 21/56

(52) U.S. Cl. CPC G06F 21/577; G06F 21/568; G06F 2221/033

(57) ABSTRACT

Disclosed are techniques for dynamically analyzing applications submitted for sharing on a data sharing platform using application security profiles. Application behavior information of the application may be obtained and a provider application security profile indicating a structure of and inputs to the application may be generated based thereon. If the application does not contain malicious code based on a scan of the provider application security profile, variations of the inputs to the application may be generated and the application may be run with the variations of the inputs to generate updated application behavior information. A replay application security profile may be generated based on the updated application behavior information. If the application does not contain any malicious code based on the scan of the replay application security profile, the application may be approved for listing on the data sharing platform.

### TECHNICAL FIELD

The present disclosure relates to sharing applications via data sharing platforms, and particularly to techniques for dynamically analyzing applications submitted for sharing on a data sharing platform.

### BACKGROUND

Databases are widely used for data storage and access in computing applications. Databases may include one or more tables that include or reference data that can be read, modified, or deleted using queries. Databases may be used for storing and/or accessing personal information or other sensitive information. Secure storage and access of database data may be provided by encrypting and/or storing data in an encrypted form to prevent unauthorized access. In some cases, data sharing may be desirable to let other parties perform queries against a set of data.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1A is a block diagram depicting an example computing environment in which the methods disclosed herein may be implemented, in accordance with some embodiments of the present invention.

FIG. 1B is a block diagram illustrating an example virtual warehouse, in accordance with some embodiments of the present invention.

FIG. 2 is a schematic block diagram of data that may be used to implement a public or private data exchange, in accordance with some embodiments of the present invention.

FIG. 3 is a schematic block diagram of deployment of a data sharing platform that illustrates consumer and provider managed data access techniques, in accordance with some embodiments of the present invention.

FIG. 4 is a block diagram of a deployment of a data sharing platform, illustrating application sharing techniques, in accordance with some embodiments of the present invention.

FIGS. 5A-5E are block diagrams of a deployment of a data sharing platform configured for dynamically analyzing applications submitted for sharing on the data sharing platform using application security profiles, in accordance with some embodiments of the present invention.

FIG. 6 is a block diagram of a method for dynamically analyzing applications submitted for sharing on a data sharing platform using application security profiles, in accordance with some embodiments of the present invention.

FIG. 7 is a block diagram of an example computing device that may perform one or more of the operations described herein, in accordance with some embodiments of the present invention.

### DETAILED DESCRIPTION

Data providers often have data assets that are cumbersome to share. A data asset may be data that is of interest to another entity. For example, a large online retail company may have a data set that includes the purchasing habits of millions of consumers over the last ten years. This data set may be large. If the online retailer wishes to share all or a portion of this data with another entity, the online retailer may need to use old and slow methods to transfer the data, such as a file-transfer-protocol (FTP), or even copying the data onto physical media and mailing the physical media to the other entity. This has several disadvantages. First, it is slow as copying terabytes or petabytes of data can take days. Second, once the data is delivered, the provider cannot control what happens to the data. The recipient can alter the data, make copies, or share it with other parties. Third, the only entities that would be interested in accessing such a large data set in such a manner are large corporations that can afford the complex logistics of transferring and processing the data as well as the high price of such a cumbersome data transfer. Thus, smaller entities (e.g., “mom and pop” shops) or even smaller, more nimble cloud-focused startups are often priced out of accessing this data, even though the data may be valuable to their businesses. This may be because raw data assets are generally too unpolished and full of potentially sensitive data to simply outright sell/provide to other companies. Data cleaning, de-identification, aggregation, joining, and other forms of data enrichment need to be performed by the owner of data before it is shareable with another party. This is time-consuming and expensive. Finally, it is difficult to share data assets with many entities because traditional data sharing methods do not allow scalable sharing for the reasons mentioned above. Traditional sharing methods also introduce latency and delays in terms of all parties having access to the most recently-updated data.

A data sharing platform may be an appropriate place to discover, assemble, clean, and enrich data to make it more monetizable. A large company on a data sharing platform may assemble data from across its divisions and departments, which could become valuable to another company. In addition, participants in a private ecosystem data sharing platform may work together to join their datasets together to jointly create a useful data product that any one of them alone would not be able to produce. Once these joined datasets are created, they may be listed on the data sharing platform.

One example of a data sharing platform is a data exchange. Private and public data exchanges may allow data providers to more easily and securely share their data assets with other entities. A public data exchange may provide a centralized repository with open access where a data provider may publish and control live and read-only data sets to thousands of consumers. A private data exchange (also referred to herein as a “data exchange”) may be under the data provider's brand, and the data provider may control who can gain access to it. The data exchange may be for internal use only, or may also be opened to consumers, partners, suppliers, or others. The data provider may control what data assets are listed as well as control who has access to which sets of data. This allows for a seamless way to discover and share data both within a data provider's organization and with its business partners.

The data exchange may be facilitated by a cloud computing service such as the SNOWFLAKE™ cloud computing service, and allows data providers to offer data assets directly from their own online domain (e.g., website) in a private online marketplace with their own branding. The data exchange may provide a centralized, managed hub for an entity to list internally or externally-shared data assets, inspire data collaboration, and also to maintain data governance and to audit access. With the data exchange, data providers may be able to share data without copying it between companies. Data providers may invite other entities to view their data listings, control which data listings appear in their private online marketplace, control who can access data listings and how others can interact with the data assets connected to the listings. This may be thought of as a “walled garden” marketplace, in which visitors to the garden must be approved and access to certain listings may be limited.

As an example, Company A may be a consumer data company that has collected and analyzed the consumption habits of millions of individuals in several different categories. Their data sets may include data in the following categories: online shopping, video streaming, electricity consumption, automobile usage, internet usage, clothing purchases, mobile application purchases, club memberships, and online subscription services. Company A may desire to offer these data sets (or subsets or derived products of these data sets) to other entities. For example, a new clothing brand may wish to access data sets related to consumer clothing purchases and online shopping habits. Company A may support a page on its website that is or functions substantially similar to a data exchange, where a data consumer (e.g., the new clothing brand) may browse, explore, discover, access and potentially purchase data sets directly from Company A. Further, Company A may control: who can enter the data exchange, the entities that may view a particular listing, the actions that an entity may take with respect to a listing (e.g., view only), and any other suitable action. In addition, a data provider may combine its own data with other data sets from, e.g., a public data exchange (also referred to as a “data marketplace”), and create new listings using the combined data.

Sharing data may be performed when a data provider creates a share object (hereinafter referred to as a share) of a database in the data provider's account and grants the share access to particular objects (e.g., tables, secure views, and secure user-defined functions (UDFs)) of the database. Then, a read-only database may be created using information provided in the share. Access to this database may be controlled by the data provider. A “share” encapsulates all of the information required to share data in a database. A share may include at least three pieces of information: (1) privileges that grant access to the database(s) and the schema containing the objects to share, (2) the privileges that grant access to the specific objects (e.g., tables, secure views, and secure UDFs), and (3) the consumer accounts with which the database and its objects are shared. The consumer accounts with which the database and its objects are shared may be indicated by a list of references to those consumer accounts contained within the share object. Only those consumer accounts that are specifically listed in the share object may be allowed to look up, access, and/or import from this share object. By modifying the list of references of other consumer accounts, the share object can be made accessible to more accounts or be restricted to fewer accounts.

In some embodiments, each share object contains a single role. Grants between this role and objects define what objects are being shared and with what privileges these objects are shared. The role and grants may be similar to any other role and grant system in the implementation of role-based access control. By modifying the set of grants attached to the role in a share object, more objects may be shared (by adding grants to the role), fewer objects may be shared (by revoking grants from the role), or objects may be shared with different privileges (by changing the type of grant, for example to allow write access to a shared table object that was previously read-only). In some embodiments, share objects in a provider account may be imported into the target consumer account using alias objects and cross-account role grants.

When data is shared, no data is copied or transferred between users. Sharing is accomplished through the cloud computing services of a cloud computing service provider such as SNOWFLAKE™. Shared data may then be used to process SQL queries, possibly including joins, aggregations, or other analysis. In some instances, a data provider may define a share such that “secure joins” are permitted to be performed with respect to the shared data. A secure join may be performed such that analysis may be performed with respect to shared data but the actual shared data is not accessible by the data consumer (e.g., recipient of the share).

A data exchange may also implement role-based access control to govern access to objects within consumer accounts using account level roles and grants. In one embodiment, account level roles are special objects in a consumer account that are assigned to users. Grants between these account level roles and database objects define what privileges the account level role has on these objects. For example, a role that has a usage grant on a database can “see” this database when executing the command “show databases”; a role that has a select grant on a table can read from this table but not write to the table. The role would need to have a modify grant on the table to be able to write to it.

Because consumers of data often require the ability to perform various functions on data that has been shared with them, a data exchange may enable users of a data marketplace to build native applications that can be shared with other users of the data marketplace. The native applications can be published and discovered in the data marketplace like any other data listing, and consumers can install them in their local data marketplace account to serve their data processing needs. This helps to bring data processing services and capabilities to consumers instead of requiring a consumer to share data with e.g., a service provider who can perform these data processing services and share the processed data back to the consumer. Stated differently, instead of a consumer having to share potentially sensitive data with a third party who can perform the necessary data processing services and send the results back to the consumer, the desired data processing functionality may be encapsulated, and then shared with the consumer so that the consumer does not have to share their potentially sensitive data.

Native applications can often be built and shared using custom built container images as well as arbitrary third party images. However, the manner in which a data exchange builds and shares applications using containers may also make it easier for malicious code and vulnerabilities to be executed and exploited in a container. For example, the data exchange may have few to no restrictions on the programming languages that a provider can use to run inside their container. This creates security issues because implementing static analysis rules for multiple languages is difficult. In addition, statically analyzing containers presents different challenges compared to analyzing regular shared application artifacts. For example, container images can be built by providers or they can be third party images which a provider may have sourced from anywhere (e.g., the internet, third parties). This means there can be arbitrary code packaged inside the container image. Container images are also dense in code (e.g., as they can account for a majority or even all of an application's functionality) and malicious code is often unstructured. Thus, it is very easy to include malicious code (e.g., a malicious UDF with excessive privileges) inside a container image, and it is virtually impossible to analyze for such code statically owing to the limitations of static analysis. This problem is further exacerbated by the fact that container images are mutable in the sense that container images the data exchange analyzes statically might not be the same once they are running as containers since they can download arbitrary code and/or run shell commands that changes their behavior.

Embodiments of the present disclosure address the above and other issues by providing techniques for dynamically analyzing applications submitted for sharing on a data exchange using application security profiles. When an application is submitted for sharing on the data exchange, a native application sharing framework of the data exchange may obtain application behavior information indicating runtime behavior of the application. The native application sharing framework may generate a provider application security profile based on the application behavior information. The provider application security profile may comprise inputs to the application such as payloads of requests to ingress endpoints of the application and queries executed by UDFs and stored procedures of the application. The native application sharing framework may scan the provider application security profile to determine whether the application contains malicious code. If the application does not contain malicious code based on the scan of the provider application security profile, the native application sharing framework may subject the application to a dynamic analysis.

During the dynamic analysis, the native application sharing framework may generate variations of the inputs to the application (based in part on the provider application security profile) and run the application with the variations of the inputs to generate updated application behavior information. A replay application security profile may be generated based on the updated application behavior information. The native application sharing framework may scan the replay application security profile to determine if the application contains any malicious code. If the native application sharing framework determines that the application does not contain any malicious code based on the scan of the replay application security profile, it may approve the application for listing on the data exchange.

The native application sharing framework may periodically generate a production application security profile for an installed instance of the application based on live application behavior information generated by any installed instances of application while executing. The native application sharing framework may compare deviations between the production application security profile and the replay application security profile to determine if reprofiling is necessary.

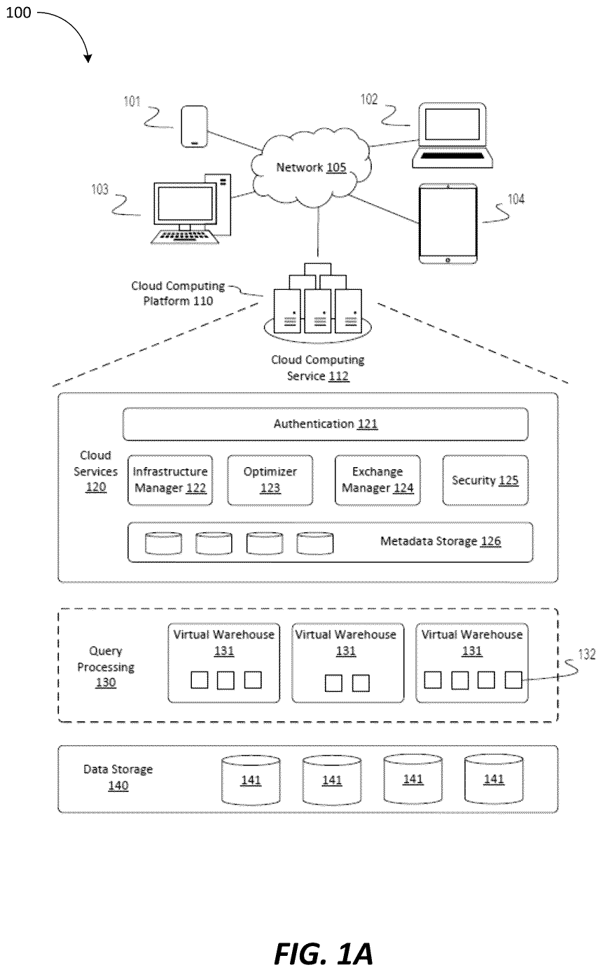

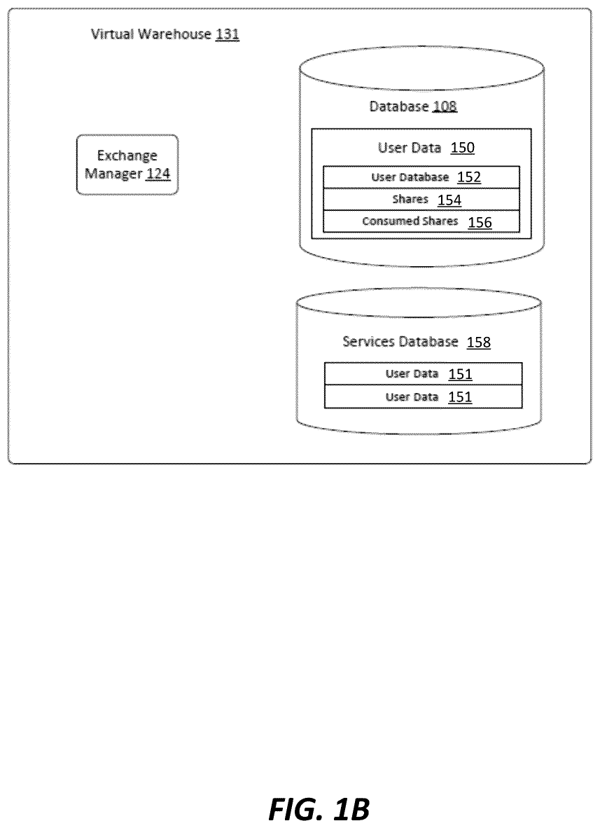

FIG. 1A is a block diagram of an example computing environment 100 in which the systems and methods disclosed herein may be implemented. A cloud computing platform 110 may be implemented, such as Amazon Web Services™ (AWS), Microsoft Azure™, Google Cloud™, or the like. As known in the art, a cloud computing platform 110 provides computing resources and storage resources that may be acquired (purchased) or leased and configured to execute applications and store data.

The cloud computing platform 110 may host a cloud computing service 112 that facilitates storage of data on the cloud computing platform 110 (e.g. data management and access) and analysis functions (e.g. SQL queries, analysis), as well as other computation capabilities (e.g., secure data sharing between users of the cloud computing platform 110). The cloud computing platform 110 may include a three-tier architecture: data storage 140, query processing 130, and cloud services 120.

Data storage 140 may facilitate the storing of data on the cloud computing platform 110 in one or more cloud databases 141. Data storage 140 may use a storage service such as Amazon S3™ to store data and query results on the cloud computing platform 110. In particular embodiments, to load data into the cloud computing platform 110, data tables may be horizontally partitioned into large, immutable files which may be analogous to blocks or pages in a traditional database system. Within each file, the values of each attribute or column are grouped together and compressed using a scheme sometimes referred to as hybrid columnar. Each table has a header which, among other metadata, contains the offsets of each column within the file.

In addition to storing table data, data storage 140 facilitates the storage of temp data generated by query operations (e.g., joins), as well as the data contained in large query results. This may allow the system to compute large queries without out-of-memory or out-of-disk errors. Storing query results this way may simplify query processing as it removes the need for server-side cursors found in traditional database systems.

Query processing 130 may handle query execution within elastic clusters of virtual machines, referred to herein as virtual warehouses or data warehouses. Thus, query processing 130 may include one or more virtual warehouses 131, which may also be referred to herein as data warehouses. The virtual warehouses 131 may be one or more virtual machines operating on the cloud computing platform 110. The virtual warehouses 131 may be compute resources that may be created, destroyed, or resized at any point, on demand. This functionality may create an “elastic” virtual warehouse that expands, contracts, or shuts down according to the user's needs. Expanding a virtual warehouse involves generating one or more compute nodes 132 to a virtual warehouse 131. Contracting a virtual warehouse involves removing one or more compute nodes 132 from a virtual warehouse 131. More compute nodes 132 may lead to faster compute times. For example, a data load which takes fifteen hours on a system with four nodes might take only two hours with thirty-two nodes.

Cloud services 120 may be a collection of services that coordinate activities across the cloud computing service 112. These services tie together all of the different components of the cloud computing service 112 in order to process user requests, from login to query dispatch. Cloud services 120 may operate on compute instances provisioned by the cloud computing service 112 from the cloud computing platform 110. Cloud services 120 may include a collection of services that manage virtual warehouses, queries, transactions, data exchanges, and the metadata associated with such services, such as database schemas, access control information, encryption keys, and usage statistics. Cloud services 120 may include, but not be limited to, authentication engine 121, infrastructure manager 122, optimizer 123, exchange manager 124, security engine 125, and metadata storage 126.

FIG. 1B is a block diagram illustrating an example virtual warehouse 131. The exchange manager 124 may facilitate the sharing of data between data providers and data consumers, using, for example, a data exchange. For example, cloud computing service 112 may manage the storage and access of a database 108. The database 108 may include various instances of user data 150 for different users e.g., different enterprises or individuals. The user data 150 may include a user database 152 of data stored and accessed by that user. The user database 152 may be subject to access controls such that only the owner of the data is allowed to change and access the user database 152 upon authenticating with the cloud computing service 112. For example, data may be encrypted such that it can only be decrypted using decryption information possessed by the owner of the data. Using the exchange manager 124, specific data from a user database 152 that is subject to these access controls may be shared with other users in a controlled manner. In particular, a user may specify shares 154 that may be shared in a public or data exchange in an uncontrolled manner or shared with specific other users in a controlled manner as described above. A “share” encapsulates all of the information required to share data in a database. A share may include at least three pieces of information: (1) privileges that grant access to the database(s) and the schema containing the objects to share, (2) the privileges that grant access to the specific objects (e.g., tables, secure views, and secure UDFs), and (3) the consumer accounts with which the database and its objects are shared. When data is shared, no data is copied or transferred between users. Sharing is accomplished through the cloud services 120 of cloud computing service 112.

Sharing data may be performed when a data provider creates a share of a database in the data provider's account and grants access to particular objects (e.g., tables, secure views, and secure user-defined functions (UDFs)). Then a read-only database may be created using information provided in the share. Access to this database may be controlled by the data provider.

Shared data may then be used to process SQL queries, possibly including joins, aggregations, or other analysis. In some instances, a data provider may define a share such that “secure joins” are permitted to be performed with respect to the shared data. A secure join may be performed such that analysis may be performed with respect to shared data but the actual shared data is not accessible by the data consumer (e.g., recipient of the share). A secure join may be performed as described in U.S. application Ser. No. 16/368,339, filed Mar. 18, 2019.

User devices 101-104, such as laptop computers, desktop computers, mobile phones, tablet computers, cloud-hosted computers, cloud-hosted serverless processes, or other computing processes or devices may be used to access the virtual warehouse 131 or cloud service 120 by way of a network 105, such as the Internet or a private network.

In the description below, actions are ascribed to users, particularly consumers and providers. Such actions shall be understood to be performed with respect to devices 101-104 operated by such users. For example, notification to a user may be understood to be a notification transmitted to devices 101-104, an input or instruction from a user may be understood to be received by way of the user's devices 101-104, and interaction with an interface by a user shall be understood to be interaction with the interface on the user's devices 101-104. In addition, database operations (joining, aggregating, analysis, etc.) ascribed to a user (consumer or provider) shall be understood to include performing of such actions by the cloud computing service 112 in response to an instruction from that user.

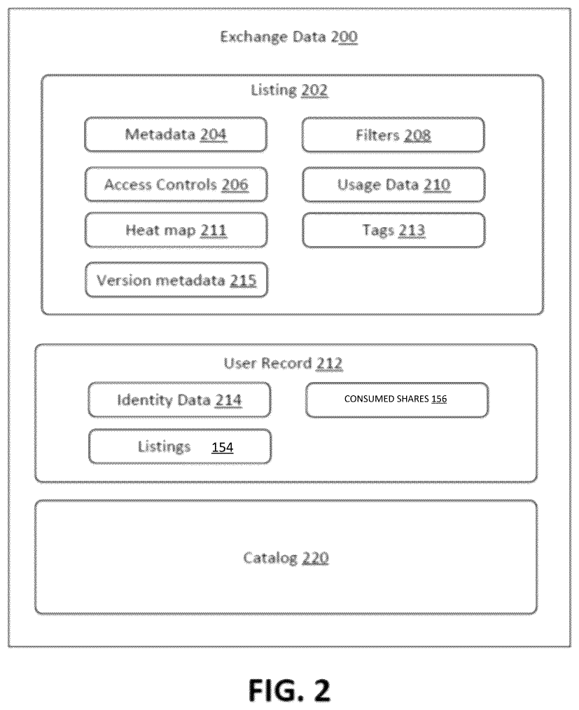

FIG. 2 is a schematic block diagram of data that may be used to implement a public or data exchange in accordance with an embodiment of the present invention. The exchange manager 124 may operate with respect to some or all of the illustrated exchange data 200, which may be stored on the platform executing the exchange manager 124 (e.g., the cloud computing platform 110) or at some other location. The exchange data 200 may include a plurality of listings 202 describing data that is shared by a first user (“the provider”). The listings 202 may be listings in a data exchange or in a data marketplace. The access controls, management, and governance of the listings may be similar for both a data marketplace and a data exchange.

The listing 202 may include access controls 206, which may be configurable to any suitable access configuration. For example, access controls 206 may indicate that the shared data is available to any member of the private exchange without restriction (an “any share” as used elsewhere herein). The access controls 206 may specify a class of users (members of a particular group or organization) that are allowed to access the data and/or see the listing. The access controls 206 may specify that a “point-to-point” share in which users may request access but are only allowed access upon approval of the provider. The access controls 206 may specify a set of user identifiers of users that are excluded from being able to access the data referenced by the listing 202.

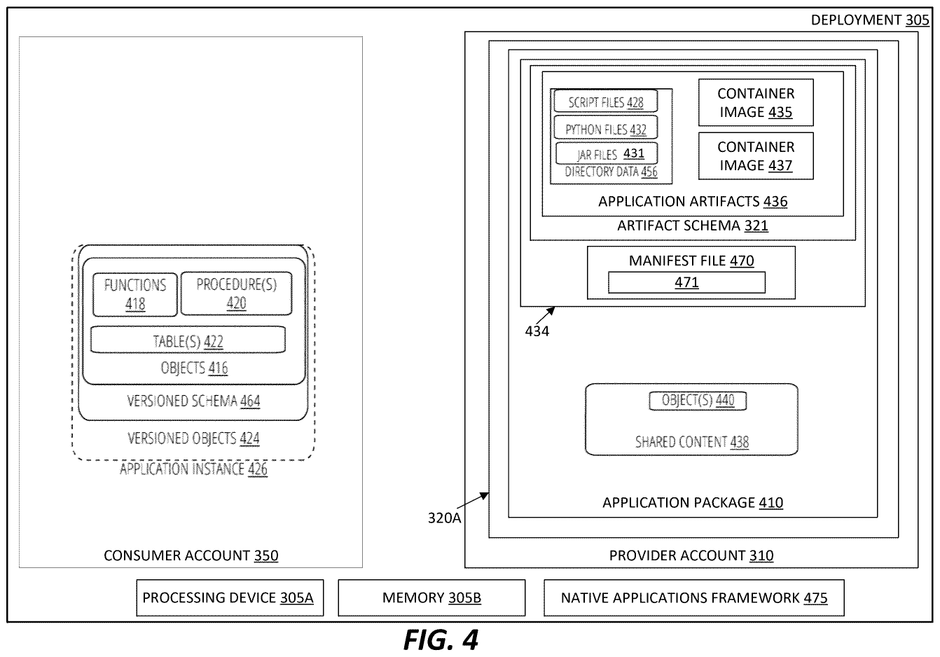

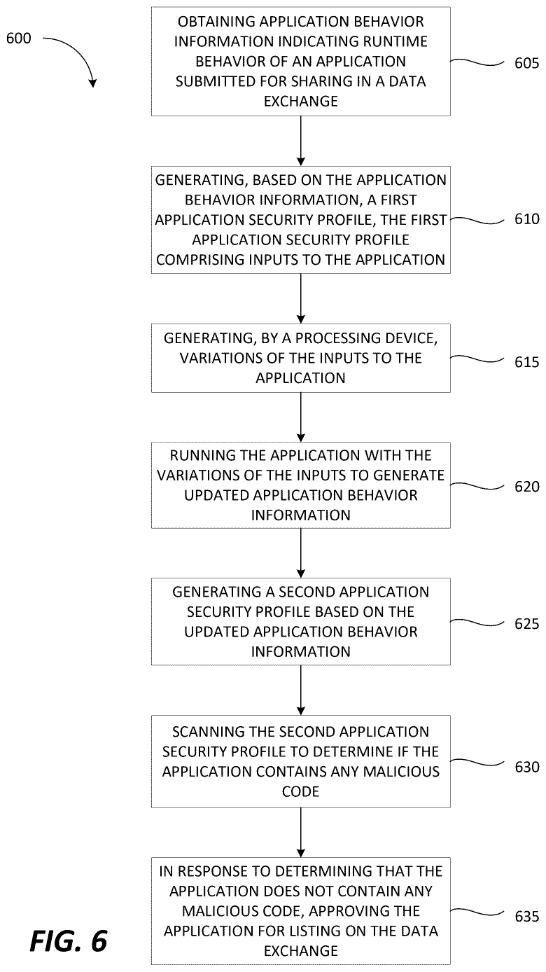

Note that some listings 202 may be discoverable by users without further authentication or access permissions whereas actual accesses are only permitted after a subsequent authentication step (see discussion of FIGS. 4 and 6). The access controls 206 may specify that a listing 202 is only discoverable by specific users or classes of users.

Note also that a default function for listings 202 is that the data referenced by the share is not exportable by the consumer. Alternatively, the access controls 206 may specify that this is not permitted. For example, access controls 206 may specify that secure operations (secure joins and secure functions as discussed below) may be performed with respect to the shared data such that viewing and exporting of the shared data is not permitted.

In some embodiments, once a user is authenticated with respect to a listing 202, a reference to that user (e.g., user identifier of the user's account with the virtual warehouse 131) is added to the access controls 206 such that the user will subsequently be able to access the data referenced by the listing 202 without further authentication.

The listing 202 may define one or more filters 208. For example, the filters 208 may define specific identity data 214 (also referred to herein as user identifiers) of users that may view references to the listing 202 when browsing the catalog 220. The filters 208 may define a class of users (users of a certain profession, users associated with a particular company or organization, users within a particular geographical area or country) that may view references to the listing 202 when browsing the catalog 220. In this manner, a private exchange may be implemented by the exchange manager 124 using the same components. In some embodiments, an excluded user that is excluded from accessing a listing 202 i.e., adding the listing 202 to the consumed shares 156 of the excluded user, may still be permitted to view a representation of the listing when browsing the catalog 220 and may further be permitted to request access to the listing 202 as discussed below. Requests to access a listing by such excluded users and other users may be listed in an interface presented to the provider of the listing 202. The provider of the listing 202 may then view demand for access to the listing and choose to expand the filters 208 to permit access to excluded users or classes of excluded users (e.g., users in excluded geographic regions or countries).

Filters 208 may further define what data may be viewed by a user. In particular, filters 208 may indicate that a user that selects a listing 202 to add to the consumed shares 156 of the user is permitted to access the data referenced by the listing but only a filtered version that only includes data associated with the identity data 214 of that user, associated with that user's organization, or specific to some other classification of the user. In some embodiments, a private exchange is by invitation: users invited by a provider to view listings 202 of a private exchange are enabled to do by the exchange manager 124 upon communicating acceptance of an invitation received from the provider.

In some embodiments, a listing 202 may be addressed to a single user. Accordingly, a reference to the listing 202 may be added to a set of “pending shares” that is viewable by the user. The listing 202 may then be added to a group of shares of the user upon the user communicating approval to the exchange manager 124.

The listing 202 may further include usage data 210. For example, the cloud computing service 112 may implement a credit system in which credits are purchased by a user and are consumed each time a user runs a query, stores data, or uses other services implemented by the cloud computing service 112. Accordingly, usage data 210 may record an amount of credits consumed by accessing the shared data. Usage data 210 may include other data such as a number of queries, a number of aggregations of each type of a plurality of types performed against the shared data, or other usage statistics. In some embodiments, usage data for a listing 202 or multiple listings 202 of a user is provided to the user in the form of a shared database, i.e. a reference to a database including the usage data is added by the exchange manager 124 to the consumed shares 156 of the user.

The listing 202 may also include a heat map 211, which may represent the geographical locations in which users have clicked on that particular listing. The cloud computing service 112 may use the heat map to make replication decisions or other decisions with the listing. For example, a data exchange may display a listing that contains weather data for Georgia, USA. The heat map 211 may indicate that many users in California are selecting the listing to learn more about the weather in Georgia. In view of this information, the cloud computing service 112 may replicate the listing and make it available in a database whose servers are physically located in the western United States, so that consumers in California may have access to the data. In some embodiments, an entity may store its data on servers located in the western United States. A particular listing may be very popular to consumers. The cloud computing service 112 may replicate that data and store it in servers located in the eastern United States, so that consumers in the Midwest and on the East Coast may also have access to that data.

The listing 202 may also include one or more tags 213. The tags 213 may facilitate simpler sharing of data contained in one or more listings. As an example, a large company may have a human resources (HR) listing containing HR data for its internal employees on a data exchange. The HR data may contain ten types of HR data (e.g., employee number, selected health insurance, current retirement plan, job title, etc.). The HR listing may be accessible to 100 people in the company (e.g., everyone in the HR department). Management of the HR department may wish to add an eleventh type of HR data (e.g., an employee stock option plan). Instead of manually adding this to the HR listing and granting each of the 100 people access to this new data, management may simply apply an HR tag to the new data set and that can be used to categorize the data as HR data, list it along with the HR listing, and grant access to the 100 people to view the new data set.

The listing 202 may also include version metadata 215. Version metadata 215 may provide a way to track how the datasets are changed. This may assist in ensuring that the data that is being viewed by one entity is not changed prematurely. For example, if a company has an original data set and then releases an updated version of that data set, the updates could interfere with another user's processing of that data set, because the update could have different formatting, new columns, and other changes that may be incompatible with the current processing mechanism of the recipient user. To remedy this, the cloud computing service 112 may track version updates using version metadata 215. The cloud computing service 112 may ensure that each data consumer accesses the same version of the data until they accept an updated version that will not interfere with current processing of the data set.

The exchange data 200 may further include user records 212. The user record 212 may include data identifying the user associated with the user record 212, e.g. an identifier (e.g., warehouse identifier) of a user having user data 151 in service database 158 and managed by the virtual warehouse 131.

The user record 212 may list shares associated with the user, e.g., listings 154 (shares 154) created by the user. The user record 212 may list shares consumed by the user i.e., consumed shares 156 which may be listings 202 created by another user and that have been associated to the account of the user according to the methods described herein. For example, a listing 202 may have an identifier that will be used to reference it in the shares or consumed shares 156 of a user record 212.

The listing 202 may also include metadata 204 describing the shared data. The metadata 204 may include some or all of the following information: an identifier of the provider of the shared data, a URL associated with the provider, a name of the share, a name of tables, a category to which the shared data belongs, an update frequency of the shared data, a catalog of the tables, a number of columns and a number of rows in each table, as well as name for the columns. The metadata 204 may also include examples to aid a user in using the data. Such examples may include sample tables that include a sample of rows and columns of an example table, example queries that may be run against the tables, example views of an example table, example visualizations (e.g., graphs, dashboards) based on a table's data. Other information included in the metadata 204 may be metadata for use by business intelligence tools, text description of data contained in the table, keywords associated with the table to facilitate searching, a link (e.g., URL) to documentation related to the shared data, and a refresh interval indicating how frequently the shared data is updated along with the date the data was last updated.

The metadata 204 may further include category information indicating a type of the data/service (e.g., location, weather), industry information indicating who uses the data/service (e.g., retail, life sciences), and use case information that indicates how the data/service is used (e.g., supply chain optimization, or risk analysis). For instance, retail consumers may use weather data for supply chain optimization. A use case may refer to a problem that a consumer is solving (i.e., an objective of the consumer) such as supply chain optimization. A use case may be specific to a particular industry, or can apply to multiple industries. Any given data listing (i.e., dataset) can help solve one or more use cases, and hence may be applicable to multiple use cases.

The exchange data 200 may further include a catalog 220. The catalog 220 may include a listing of all available listings 202 and may include an index of data from the metadata 204 to facilitate browsing and searching according to the methods described herein. In some embodiments, listings 202 are stored in the catalog in the form of JavaScript Object Notation (JSON) objects.

Note that where there are multiple instances of the virtual warehouse 131 on different cloud computing platforms, the catalog 220 of one instance of the virtual warehouse 131 may store listings or references to listings from other instances on one or more other cloud computing platforms 110. Accordingly, each listing 202 may be globally unique (e.g., be assigned a globally unique identifier across all of the instances of the virtual warehouse 131). For example, the instances of the virtual warehouses 131 may synchronize their copies of the catalog 220 such that each copy indicates the listings 202 available from all instances of the virtual warehouse 131. In some instances, a provider of a listing 202 may specify that it is to be available on only specified one or more computing platforms 110.

In some embodiments, the catalog 220 is made available on the Internet such that it is searchable by a search engine such as the Bing™ search engine or the Google search engine. The catalog may be subject to a search engine optimization (SEO) algorithm to promote its visibility. Potential consumers may therefore browse the catalog 220 from any web browser. The exchange manager 124 may expose uniform resource locators (URLs) linked to each listing 202. This URL may be searchable and can be shared outside of any interface implemented by the exchange manager 124. For example, the provider of a listing 202 may publish the URLs for its listings 202 in order to promote usage of its listing 202 and its brand.

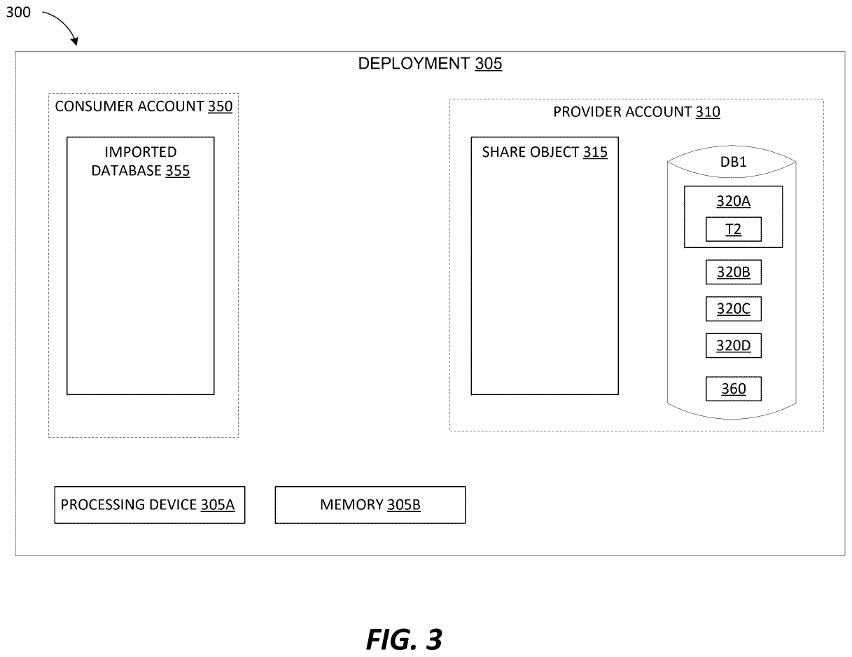

FIG. 3 illustrates a cloud environment 300 comprising a cloud deployment 305, which may comprise a similar architecture to cloud computing service 112 (illustrated in FIG. 1A) and may be a deployment of a data exchange or data marketplace. Although illustrated with a single cloud deployment, the cloud environment 300 may have multiple cloud deployments which may be physically located in separate remote geographical regions but may all be deployments of a single data exchange or data marketplace. Although embodiments of the present disclosure are described with respect to a data exchange, this is for example purpose only and the embodiments of the present disclosure may be implemented in any appropriate enterprise database system or data sharing platform where data may be shared among users of the system/platform.

The cloud deployment 305 may include hardware such as processing device 305A (e.g., processors, central processing units (CPUs), memory 305B (e.g., random access memory (RAM), storage devices (e.g., hard-disk drive (HDD), solid-state drive (SSD), etc.), and other hardware devices (e.g., sound card, video card, etc.). A storage device may comprise a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices. The cloud deployment 305 may comprise any suitable type of computing device or machine that has a programmable processor including, for example, server computers, desktop computers, laptop computers, tablet computers, smartphones, set-top boxes, etc. In some examples, the cloud deployment 305 may comprise a single machine or may include multiple interconnected machines (e.g., multiple servers configured in a cluster).

Databases and schemas may be used to organize data stored in the cloud deployment 305 and each database may belong to a single account within the cloud deployment 305. Each database may be thought of as a container having a classic folder hierarchy within it. Each database may be a logical grouping of schemas and a schema may be a logical grouping of database objects (tables, views, etc.). Each schema may belong to a single database. Together, a database and a schema may comprise a namespace. When performing any operations on objects within a database, the namespace is inferred from the current database and the schema that is in use for the session. If a database and schema are not in use for the session, the namespace must be explicitly specified when performing any operations on the objects. As shown in FIG. 3, the cloud deployment 305 may include a provider account 310 including database DB1 having schemas 320A-320D.

FIG. 3 also illustrates share-based access to objects in the provider account 310. The provider account 310 may create a share object 315, which includes grants to database DB1 and schema 320A, as well as a grant to a table T2 located in schema 320A. The grants on database DB1 and schema 320A may be usage grants and the grant on table T2 may be a select grant. In this case, the table T2 in schema 320A in database DB1 would be shared read-only. The share object 315 may contain a list of references (not shown) to various consumer accounts, including the consumer account 350.

After the share object 315 is created, it may be imported or referenced by consumer account 350 (which has been listed in the share object 315). Consumer account 350 may run a command to list all available share objects for importing. Only if the share object 315 was created with a reference to the consumer account 350, then the consumer account 350 reveals the share object using the command to list all share objects and subsequently import it. In one embodiment, references to a share object in another account are always qualified by account name. For example, consumer account 350 would reference a share object SH1 in provider account A1 with the example qualified name “A1.SH1.” Upon the share object 315 being imported to consumer account 350 (shown as imported database 355), an administrator role (e.g., an account level role) of the consumer account 350 may be given a usage grant to the imported database 355. In this way, a user in account 350 with the administrator role 350A may access data from DB1 that is explicitly shared/included in the share object 315.

Similar to the way that data can be shared from a provider account to a consumer account, applications can also be shared from a provider account to a consumer account. As with sharing of data, sharing of a native application (hereinafter referred to as an application) may be performed using a shared container.

FIG. 4 illustrates an example native application sharing process taking place within the deployment 305. It should be noted that embodiments of the present disclosure may be used with any native application sharing process and the process illustrated in FIG. 4 is not limiting. Upon creating the database DB1 and the schema 320A, the provider account 310 may generate an application package 410 and store it in the schema 320A. The provider account 310 may define the application package 410 with the necessary functionality to install the application (including any objects and procedures required by the application) in the consumer account 350. The native applications framework 475 may enable the provider account 310 to indicate that the application package 410 will automatically be invoked with no arguments when a consumer with whom the application package 410 has been shared requests installation of the application. The provider account 310 may create an application share object (not shown) and attach the application package 410 to the application share object. The provider account 310 may then grant the necessary privileges to the application share object including usage on the database DB1, usage on the schema 320A, and usage on the application package 410.

When the consumer account 350 runs a command to see the available listings, they may see a listing corresponding to the application share object and may run a command to create an instance of application 426 from the listing (e.g., CREATE APPLICATION <name> FROM LISTING <listing name>). In response to execution of the command, the native applications framework 475 may automatically trigger execution of script files 428 of the application package 410, which may create objects (e.g., credentials, API integration, and a warehouse) as well as tasks/procedures corresponding to the functionality of the application instance 426 in the consumer account 350 as discussed in further detail herein. The native applications framework 475 may also create containers (not shown) corresponding to the functionality of the application instance 426 in the consumer account 350 using the container images 435 and 437. It should be noted that in some embodiments, the entire functionality of the application instance 426 may be implemented using containers and thus the application artifacts 436 may only include container images corresponding to the functionality of the application instance 426. The consumer account 350 may also grant privileges necessary for the application instance 426 to run (some privileges are granted on objects managed and owned by the consumer account 350) including usage on secrets, usage on the API Integration, usage on the warehouse, and privileges granted to the application instance 426 if it needs to access objects of the consumer account 350 or execute procedures in the consumer account 350. Once installed, the application instance 426 may perform various functions in the consumer account 350 as long as the consumer account 350 has authorized it. The application instance 426 can act as an agent, and take any action that any role on the consumer account 350 could take such as e.g., set up a task pipeline, set up data ingestion (e.g., via Snowpipe™ ingestion), or any other defined functionality of the application instance 426. The application instance 426 may act on behalf of the consumer account 350 and execute procedures in a programmatic way.

As shown in FIG. 4, the application package 410 is used by the provider account 310 to create a database application that can be provided to the consumer account 350. Once properly instantiated, such as application instance 426, the application can be executed by the consumer account 350 and access content off the application package 410 that is shared to application instance 426 including one or more objects, such as objects 440, in a secure manner.

The application package 410 comprises one or more application artifacts 436 in the form of executable objects such as, but not limited to container images 435 and 437, script files 428, python files 432, and jar files 431, that are stored in an application artifacts datastore such as a named filesystem scoped to the artifact schema 321 associated with the provider account 310. In some examples, the datastore for the application artifacts 436 includes directory data 456 accessed by the consumer application instance 426 at run time in the consumer account 454 for storage of the executable files once the application instance 426 has been instantiated. In some examples, the application artifacts 436 are defined in the artifact schema 321. In some examples, the artifact schema 321 contains script files 428 that are executed within the application instance 426 to define the application. In some examples, an application may have none or more application package versions that are containers for the artifact schema 321 and the named storage location 434.

The application package 410 further comprises shared content 438 comprising one or more data objects, such as objects 440, that constitute objects shared to the application instance 426 that are accessed and/or operated on by the application instance 426 during execution of executable objects of the versioned schema 464 of the application instance 426 such as, but not limited to, functions 418 and procedures 420. In some examples, the application package 410 includes shared content comprising one or more schemas containing objects such as, but not limited to, tables, views, and the like. In some examples, the shared content 438 is accessed by the application instance 426 based on a set of security protocols.

The application instance 426 comprises a set of versioned objects 424 that are created during the instantiation of the application instance 426. The versioned objects 424 include objects 416 of a versioned schema 464 that are defined by the application artifacts 436. In some examples, the objects 416 comprise one or more functions 418, one or more procedures 420, one or more tables 422, and the like.

In some examples, when the application instance 426 is being upgraded to a new version, the setup script modifies existing objects of the application instance 426. In some examples, the application artifacts 436 are stored as part of the version definition of the application package 410, and are stored as e.g., java jars, python files, and the like but are not installed within the application instance 426. The application artifacts 436 are referred to from objects 416 that are installed by the installation script. For example, an object of objects 416 may be a java stored procedure that refers to a jar file that is located in the versioned schema 464, but these objects are directly accessed, at run time, in the provider package when the procedure is executed.

In some examples, when a version of the application package 410 is created, the provider account 310 specifies a location of the root directory in a named storage location for that application version, and a manifest file 470 is provided in that location. The native applications framework 475 configures one or more components of the application instance 426 based on the manifest file 470. The manifest file 470 includes properties related to the application version of the application package 410 such as a name, an application version value, a display name and the like. The manifest file 470 also includes information about runtime behavior of the application instance 426 such as, but not limited to, execution of extension code, connections to external services and the Uniform Resource Locations (URLs) of those services, running of background tasks and the like.

The native applications framework 475 may build and share applications using custom built container images as well as arbitrary third party images. However, the manner in which the native applications framework 475 builds and shares applications using containers may also make it easier for malicious code and vulnerabilities to be executed and exploited in a container. For example, the native applications framework 475 may have little to no restrictions on the programming languages that a provider can use to run inside their container. This creates security issues because implementing static analysis rules for multiple languages is difficult. In addition, statically analyzing containers presents different challenges compared to analyzing regular shared application artifacts. For example, container images can be built by providers or they can be third party images which a provider may have sourced from anywhere (e.g., the internet, third parties). This means there can be arbitrary code packaged inside the container image. Container images are also dense in code (e.g., as they can account for a majority or even all of an application's functionality) and malicious code is often unstructured. Thus, it is very easy to include malicious code (e.g., a malicious UDF with excessive privileges) inside a container image, and it is virtually impossible to analyze for such code statically owing to the limitations of static analysis. This problem is further exacerbated by the fact that container images are mutable in the sense that container images the native applications framework 475 analyzes statically might not be the same once they are running as containers since they can download arbitrary code and/or run shell commands that changes their behavior.

Other risks associated with building and sharing applications using container images include:
Dynamic code loading
Privilege escalation
Unauthorized access through public endpoints
Data exfiltration
Data exfiltration via browsers since shared applications can be web applications
Crypto mining
Ransomware
DoS scenarios (e.g., when containers request resources such as GPUs)
Requests to consumers to grant excessive privileges to shared applications via social engineering practices
Inability to detect potential attacks and vulnerabilities associated with machine learning (ML) models

Embodiments of the present disclosure provide techniques for performing dynamic analysis of applications to be shared via e.g., a data exchange, and particularly applications that implement some or all of their functionality using containers (e.g., application 426). Because such applications may include arbitrary code encompassing e.g., containers, UDFs, stored procedures, and web applications (or a combination thereof), a dynamic analysis of such an application may require an understanding of the structure of the application (e.g., the containers, UDFs, stored procedures, and web applications etc. that it is comprised of) and how the application executes. Thus, embodiments of the present disclosure provide application security profiles which specify information about the runtime behavior of an application as well as facilitate dynamic analysis of the application, as discussed in further detail herein. The application security profiles may be based on application behavior information, which includes:
Egress hosts and ports the application connects to. This includes the websites and internet endpoints (and their URLs) the application connects to.
Ingress endpoints of the application, as well as paths and payloads of requests to the ingress endpoints and paths and payloads of responses from the ingress endpoints.
UDFs and stored procedures included in the application.
Queries run by the application.
Permissions required by the application.
Packet filter monitoring logs, which are logs generated by a packet filter monitoring tool (e.g., Tetragon) that runs at the kernel level and thus can monitor system calls made by a container in which functionality of the application executes (and generate packet filter monitoring logs based thereon). The packet filter monitoring logs provide insight regarding what is happening inside the container including: processes run by the application, processes listening in the application (e.g., a server processes listening for traffic) and file actions performed by the application.

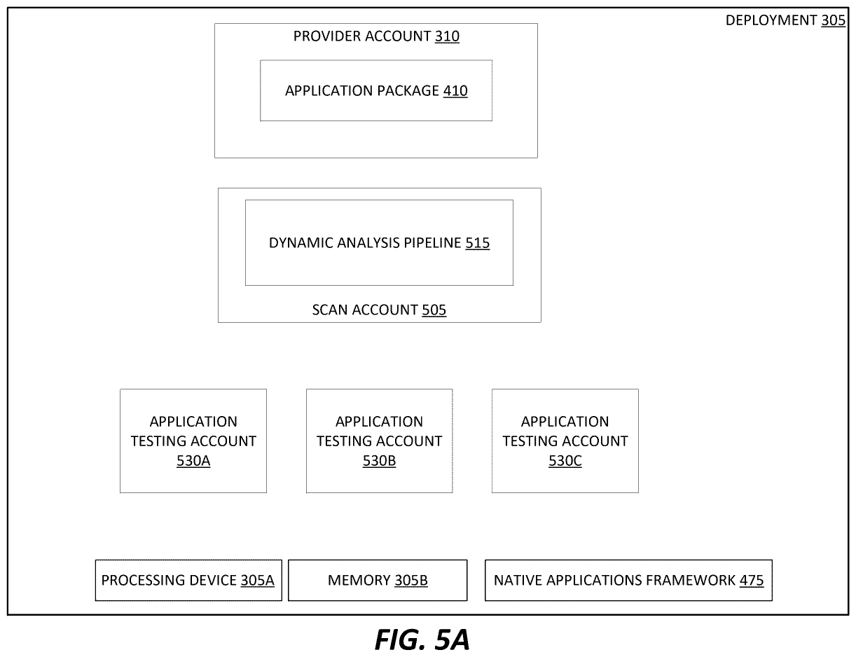

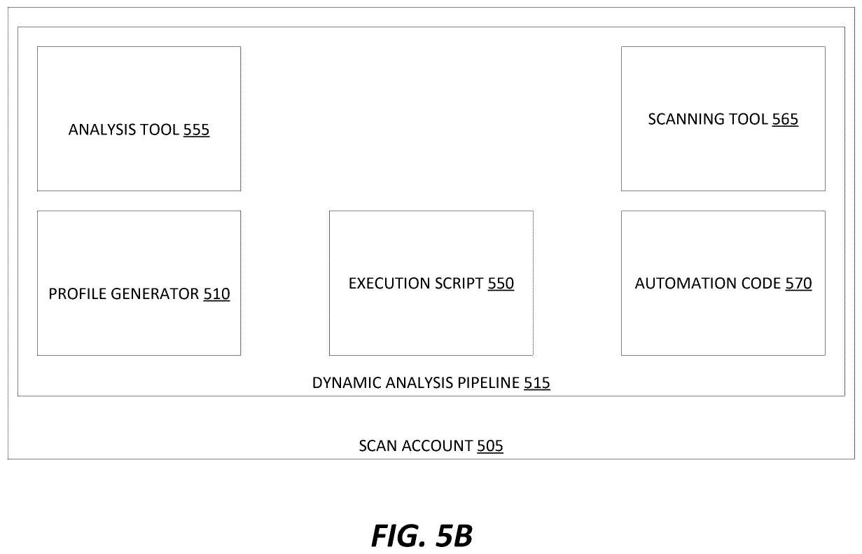

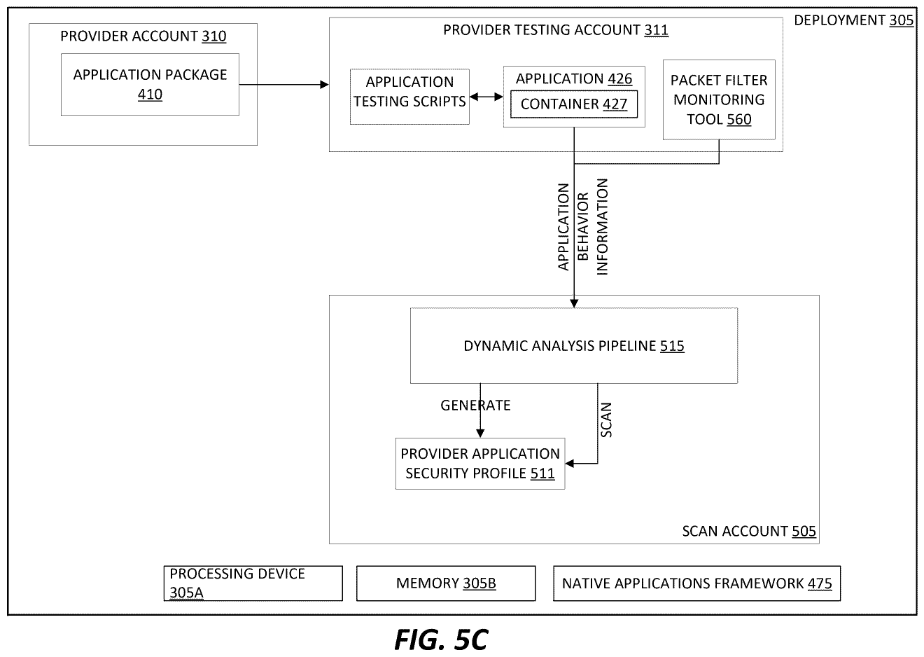

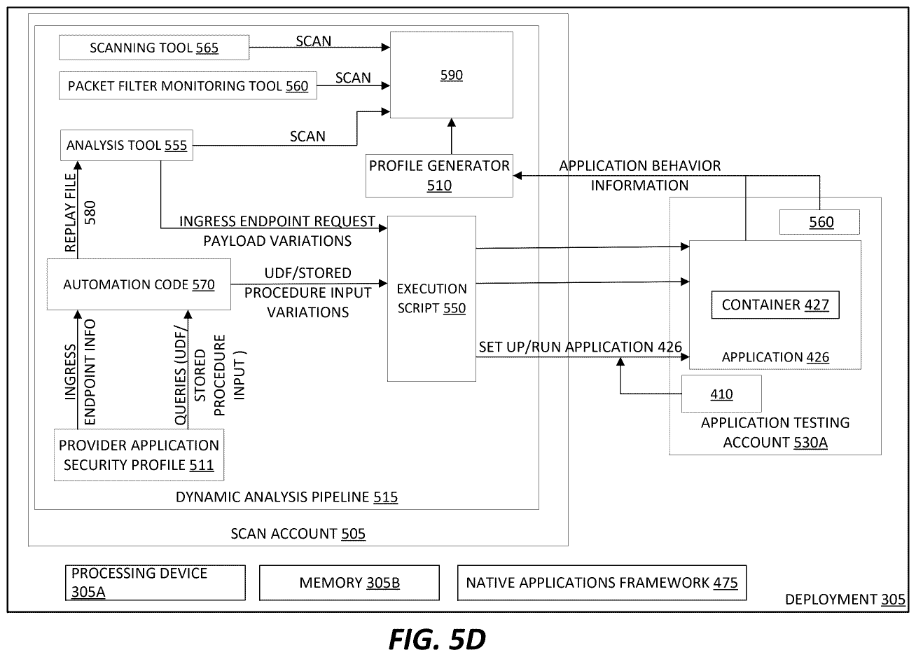

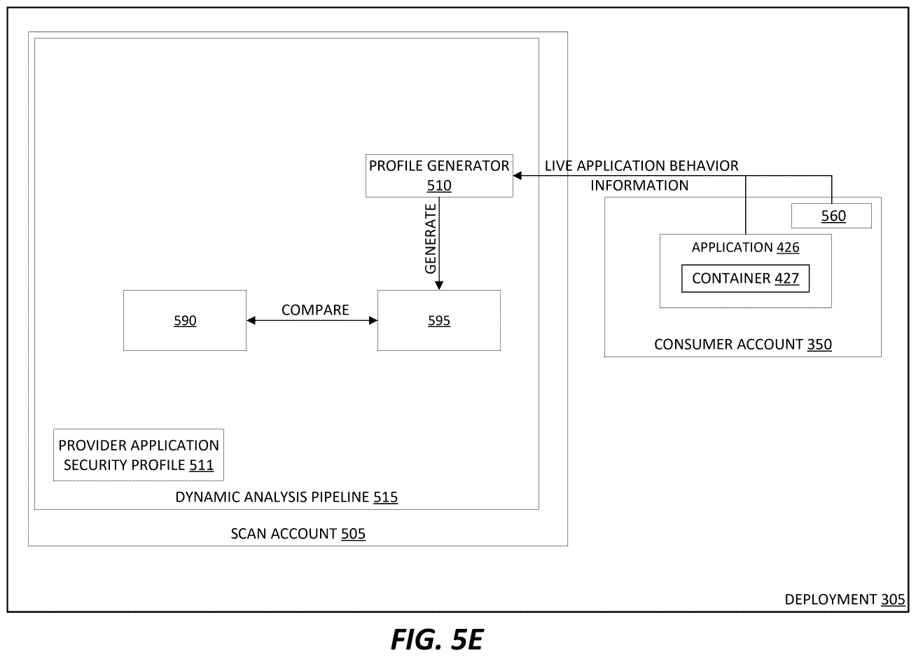

FIG. 5A illustrates the deployment 305 implementing functionality to perform a dynamic analysis of an application submitted for sharing on the data exchange (e.g., application 426) using application security profiles, in accordance with some embodiments of the present disclosure. The deployment 305 may include a scan account 505 which may host a dynamic analysis pipeline 515. In some embodiments, the functionality described herein with respect to FIGS. 5A-5E may be implemented as part of the native applications framework 475. The deployment 305 may be located in a first region among many regions in which the data exchange is available. Each region of the data exchange may include a dedicated scan account similar to scan account 505. The scan account of each region may host its own dynamic analysis pipeline so that dynamic analysis of applications submitted for sharing via the data exchange can be performed in the parent region of the shared applications. In some embodiments, the scan account 505 may be an account that hosts logic to perform static analysis of applications to be shared that has been modified to also include logic to perform a dynamic analysis as discussed herein. The deployment 305 may also include a set of application testing accounts 530A-C that function to install and run applications to be shared. The native applications framework 475 may increase the number of application testing accounts 530 on demand to add more parallelism if required. In this way, the application 426 (and any other applications submitted for sharing) can run in isolation (i.e., are effectively sandboxed).

FIG. 5B illustrates the dynamic analysis pipeline 515 in accordance with some embodiments of the present disclosure. The dynamic analysis pipeline 515 may include a profile generator 510 and an execution script 550 which is generated to run the application 426 for the purpose of performing dynamic analysis as discussed in further detail herein. The dynamic analysis pipeline 515 may further include an analysis tool 555 which may be any appropriate web application analysis tool (e.g., OWASP ZAP) and may use crawlers to identify web endpoints the application 426 connects to (and retrieve all corresponding links and URLs) as well as intercept, modify, and forward requests between browsers and the identified web endpoints.

The dynamic analysis pipeline 515 may further include a malware scanning tool 565 (e.g., Yarahunter) which may scan the relevant containers (e.g., container 427) and filesystems (not shown) of the application 426 and determine if any of the application 426's responses while executing indicate malware/malicious code etc. The malware scanning tool 565 may use a ruleset (not shown) to identify responses/resources of the application 426 that match known malware signatures, and may indicate that the container 427 or filesystem has been compromised. The dynamic analysis pipeline 515 may also utilize a packet filter monitoring tool 560 to monitor what is happening inside the container 427. The packet filter monitoring tool 560 may perform this monitoring by gathering system calls made by the container 427 (shown in FIG. 5C) running the application 426 (or part of the application 426). The packet filter monitoring tool 560 may be any appropriate packet filter program (e.g., Tetragon) and may be installed in any environment (e.g., virtual machine) where the application 426 is running. The packet filter monitoring tool 560 may monitor activities happening inside the container 427 including: processes run by the application 426, processes listening in the application 426 and file actions performed by the application 426. The dynamic analysis pipeline 515 may further include automation code 570 that automates execution of the analysis tool 555, the packet filter monitoring tool 560 and the scanning tool 565 as discussed in further detail herein.

Referring back to FIG. 5A, the dynamic analysis pipeline 515 may perform a dynamic analysis of the application 426 by automatically installing, configuring, and running the application 426 (via the execution script 550) in a test account 530 with expected and synthesized inputs to trigger/discover maximum application functionality as discussed in further detail herein. For example, running applications with expected and synthesized inputs helps in discovering hidden code paths that malicious attackers might have included in the application 426, or detecting supply chain attacks where benign providers have included a malicious third-party library by mistake. Based on this dynamic analysis, a replay application security profile may be generated that is based on updated application behavior information generated during the dynamic analysis of the application 426 (i.e., a “replay” of the application 426) as discussed in further detail herein. The replay application security profile may be analyzed to determine if the application 426 poses any security risks as discussed in further detail herein.

However, for the dynamic analysis pipeline 515 to be able to discover all of the application 426's functionality (i.e., execute the application 426 with sufficiently varied inputs to trigger/discover maximum application functionality), it needs to know the application behavior information of the application 426. Indeed, there may be multiple code paths mapped to an endpoint and although some of the application behavior information can be derived from e.g., a service function definition, there is no way to derive such information for external endpoints and web page URLs. In addition, while some information about the inputs to UDFs and stored procedures can be derived using a service function definition, it is difficult to accurately derive this information. For example, a string or variant input to a UDF can be an XML or a JSON string with a specific and complex schema and values.

Thus, for the dynamic analysis pipeline 515 to obtain the application behavior information of the application 426, it requires that when the provider account 310 first submits the application 426 for sharing on the data exchange, that it will be tested in such a way that it will generate the various metrics and logs from which the application behavior information can be obtained. Referring to FIG. 5C, in some embodiments the provider account 310 may set up and test the application 426 in their own dedicated testing environment, which may be a separate provider testing account 311 as shown in FIG. 5C. The provider account 310 may provide the application package 410 to the provider testing account 311, which will set up the application 426 using the application package 410, resulting in creation of container 427. For ease of description, the functionality of application 426 may be entirely implemented via the container 427 in the examples described herein. The provider testing account 311 may execute application testing scripts to e.g., run service functions and call external endpoints as is well known.

While the application 426 is being tested by the provider testing account 311 (also referred to herein as provider testing), the analysis tool 555 may be configured as a proxy before the ingress endpoints of the application 426 so that it can automatically capture the requests/responses (as well as their paths and payloads) for each ingress endpoint. In addition, the packet filter monitoring tool 560 may generate packet filter monitoring logs that detail system calls made by the container 427 while the application 426 is being provider tested. The system calls made by the container 427 may indicate processes run by the application 426, processes listening in the application 426 and file actions performed by the application 426. The application behavior information obtained by the analysis tool 555 and the packet filter monitoring tool 560 may be provided to the profile generator 510.

Further, while the application 426 is being provider tested, the profile generator 510 may obtain information about egress hosts (e.g., the web endpoints (and their URLs)) and ports the application 426 connects to by analyzing the application manifest (i.e., the manifest file 470 illustrated in FIG. 4) as well as the network rules and enterprise application integration (EAI not shown) used by the application 426. Any queries run by the application 426 as part of the provider testing and any permissions required for the application 426 during the testing may be stored in an account query history database (not shown) of the provider testing account 311 and/or the application manifest. Thus, the profile generator 510 may obtain information about the queries run by the application 426 and any permissions required for the application 426 during the provider testing from the account query history database of the provider testing account 311 and/or the application manifest. The profile generator 510 may obtain information about the UDFs and stored procedures included in the application 426 from the application manifest and/or the account query history database of the provider testing account 311. The profile generator 510 may obtain each aspect of the application behavior information of the application 426 as discussed hereinabove and generate a provider application security profile 511 based thereon (also referred to herein as provider profiling). Provider testing allows for automated information gathering and no manual work is required from providers to provide the information. In addition, providers can reuse existing test cases and infrastructure. Provider testing also means that applications submitted for sharing will be tested before listing on the data exchange, thereby reducing the chances of a malicious application being listed on the data exchange. Further, provider testing enables easy manifest enforcement as tested URLs can be added to a manifest automatically (and should be the only URLs and entry points allowed in an application).

In some embodiments, instead of the provider testing the application 426 itself using the provider testing account 311, they may manually document all of the web endpoint URLs and application inputs and provide them to the native applications framework 475 for testing. Providers may provide the web endpoint URLs and application inputs in any appropriate format (e.g., OpenAPI spec, web service description language (WSDL) file, GraphQL schema, or HTTP archive file) to make it easier to share the information.

The dynamic analysis pipeline 515 may then scan the provider application security profile 511 using the analysis tool 555, the packet filter monitoring tool 560 and the scanning tool 565 as well as monitor changes made to the provider testing account 311 by the application 426 to determine if any of the application behavior information obtained during the provider testing indicates malicious behavior (i.e., malware/malicious code etc.), as discussed in further detail with respect to FIG. 5D. If any malicious behavior is detected, the application 426 is rejected. If no malicious behavior is detected, the application 426 may be subjected to dynamic analysis by the dynamic analysis pipeline 515 as discussed in further detail with respect to FIG. 5D. Dynamic analysis is important not only because of the limitations of static analysis (discussed hereinabove), but also because providers may not always perform complete/thorough testing and/or may not have the capability to test for all types of malicious behavior. This is further compounded by the fact that providers usually utilize test data when performing provider testing, not actual data. As a result, the provider application security profile 511 generated based on the provider testing may not provide a complete picture of the application 426 and all of its components and behaviors.

There may be scenarios where a provider may resubmit an application that was previously profiled (i.e., previously had a provider application security profile generated for it) for listing on the data exchange. For example, the provider may have made modifications or updates to the application and now wishes to share the updated version. In such scenarios, the native applications framework 475 may provide the option to submit the updated version with the previously generated provider application security profile. If the provider elects to resubmit the application 426 (e.g., a new version) with a previously generated provider application security profile, the dynamic analysis pipeline 515 may ensure that the application 426 has not changed beyond a permissible extent by verifying that the UDFs/stored procedures/images listed in the previously generated provider application security profile match the UDFs/stored procedures/images listed in the application manifest for the resubmitted version of the application 426. If the application manifest lists UDFs/stored procedures that are not listed in the previously generated provider application security profile, the dynamic analysis pipeline 515 may reject the resubmitted application and inform the provider that they must perform the provider testing described hereinabove again so that a new provider application security profile may be generated for the resubmitted application.

Referring to FIG. 5D, the native applications framework 475 may install the application 426 in the testing account 530A using the application package 410. For the application 426 to properly function, it needs to be configured with account level privileges or resources like EAIs, compute pools and warehouses, etc. The native applications framework 475 may utilize a post install script (not shown) to automatically configure privileges and resources needed by the application 426. In some embodiments, the post install script may be part of the manifest file 470 (e.g., listed as one of the artifacts 436). Thus, the native applications framework 475 may first install the application 426 in the test account 530A and then configure it by running the post install script.

The dynamic analysis pipeline 515 may generate the execution script 550 based on the UDFs and stored procedures created in the test account 530A as part of the installation of the application 426 as well as expected inputs defined by the application behavior information in the provider application security profile 511. For example, the dynamic analysis pipeline 515 may define in the execution script 550, expected inputs for the application 426 based on queries run by the application 426 (inputs to UDFs/stored procedures) as well as requests/responses (as well as their paths and payloads) for each ingress endpoint of the application 426. The execution script 550 may also receive synthesized inputs to provide to the application 426 as part of the dynamic analysis as discussed in further detail herein.

The execution script 550 may also validate that the provider application security profile 511 indicates input for all of the UDFs/stored procedures that it lists and that none of the inputs return an error (i.e., that there are no UDFs or stored procedures included in the application 426 that are not listed in the application manifest). If the execution script 550 identifies particular UDFs/stored procedures in the provider application security profile 511 that are not listed in the application manifest, it may reject the application 426 and return it to the provider account 310 for retesting to generate a new provider application security profile that identifies the particular UDFs/stored procedures and provides inputs for the particular UDFs/stored procedures.

Once the application 426 is installed and running in the test account 530A and all the UDFs and stored procedures listed in the provider application security profile 511 are validated, the automation code 570 may extract the base URLs for any public endpoints from the application 426. Once the base URLs for any public endpoints of the application 426 are extracted, the execution script 550 may trigger dynamic analysis of the application 426 (also referred to herein as replay testing). The dynamic analysis may focus on two types of ingress to the application 426: web endpoints and UDFs/stored procedures.

As discussed hereinabove, the analysis tool 555 may identify requests/responses (as well as their paths and payloads) for each ingress endpoint of the application 426 as well as intercept, modify, and forward such requests/responses. Thus, to facilitate the dynamic analysis the automation code 570 may generate a replay file 580 (e.g., an HTTP archive file) including the ingress endpoint request payloads from the provider application security profile 511 and provide the replay file 580 to the analysis tool 555. The analysis tool 555 may generate variations of the ingress endpoint request payloads and (based on instructions from the automation code 570) may send each of the request payload variations as a request to the execution script 550. The execution script 550 may provide the request payload variations as inputs to the application 426 to attempt to trigger/discover new (i.e., undiscovered) web endpoints as well as attempt to trigger/discover new functionality in these new web endpoints as well as existing web endpoints (essentially simulating user interaction with the application 426 through a browser with a variety of different sets of input).

The automation code 570 may also simulate different user interactions to trigger/discover new UDFs and stored procedures of the application 426 as well as new functionality of existing UDFs and stored procedures of the application 426. The data corresponding to the UDF/stored procedure definitions and various queries used to trigger each of them are included in the provider application security profile 511 (as discussed hereinabove). Using this data, the automation code 570 may generate different variations of the queries for each UDF/stored procedure and send each of the query variations as a request to the execution script 550. The execution script 550 may provide each of the query variations as inputs to the application 426 to try and trigger/discover new UDFs and stored procedures, new functionality of the new UDFs and stored procedures and new functionality of existing UDFs and stored procedures of the application 426.

In this way, the dynamic analysis pipeline 515 may generate a sufficient number and variety of inputs to the application 426 to trigger maximum application functionality and thus identify any security vulnerabilities/malicious behavior in the application 426. If new code paths (e.g., UDFs, stored procedures, web end points) that were not listed in the provider application security profile 511 are discovered, the analysis tool 555 may analyze the newly discovered code paths to determine whether the dynamic analysis can continue or not. More specifically, the analysis tool 555 may analyze e.g., a newly discovered UDF to determine whether the inputs of the newly discovered UDF are simple enough that the analysis tool 555 can generate enough sufficiently varied test inputs (e.g., test queries) to thoroughly test the newly discovered UDF. For example, if the inputs to the newly discovered UDF are simple (e.g., integers or strings), the analysis tool 555 may determine that it can generate enough sufficiently varied test inputs to thoroughly test the functionality of the newly discovered UDF. However, if the analysis tool 555 determines that the inputs to the newly discovered UDF are too complex (e.g., JSON or CSV files that require custom input) for it to generate test inputs on its own, then the execution script 550 will fail the application 426 and return it to the provider account 310 for retesting and generation of a new provider application security profile that identifies the newly discovered code paths and provides inputs for the newly discovered code paths.

While the application 426 is being run by the execution script 550 as discussed hereinabove, the profile generator 510 may gather updated application behavior information of the application 426 (in the same manner as the application behavior information was gathered as discussed hereinabove) and generate a replay application security profile 590 based on the updated application behavior information (also referred to herein as replay profiling). The automation code 570 may then scan the replay application security profile 590 using the analysis tool 555, the packet filter monitoring tool 560 and the scanning tool 565 to determine if any of the updated application behavior information obtained during testing by the analysis tool 555 indicates malicious behavior. The analysis tool 555 and the packet filter monitoring tool 560 may utilize a rule-based approach when scanning the replay application security profile 590. The analysis tool 555 may implement rules to scan for behavior such as:
Redirects from application 426 to hosts not listed as allowed in the account
Window.open( ) in Javascript
Javascript obfuscation
Nodes that are not listed as allowed in the application testing account 530A
Known malicious URLs
Data exchange session cookie patterns in requests

The packet filter monitoring tool 560 may implement rules to scan for behavior such as:
Container breakout
Port Scanning
System call signatures for process injection and debugging
Shell spawns from services listening on ports
Permission changes to add execute
New file creation (e.g., download of malicious file) and execution
Requests sent to known malicious URLs

In addition to monitoring the container 427 through the packet filter monitoring tool 560, the dynamic analysis pipeline 515 will also monitor the changes made to the application testing account 530A by the application 426. Examples of such changes may include:
Persistence attempts such as creating objects outside an application database which will not be removed on uninstallation
UDFs created through dynamic code
Network integrations created by the application 426
External access integrations
Tables and views created from shared data
Data updated or deleted by the application 426

The scanning tool 565 may be used to scan the container 427 for any malware that might have been downloaded by the application 426 during the replay testing. If any malicious behavior is detected during the scans performed by the analysis tool 555, the packet filter monitoring tool 560 and the scanning tool 565, the application 426 is rejected. If no malicious behavior is detected, the application 426 may be approved for listing on the data exchange.

Once the application 426 has been listed on the data exchange, the profile generator 510 may periodically generate a production application security profile for an installed instance of the application 426. The dynamic analysis pipeline 515 may compare the production application security profile to the replay application security profile 590 to identify any deviations in the live (installed) instance of the application 426 from the version of the application 426 that was dynamically analyzed to generate the replay application security profile 590. Deviations in live instances of the application 426 can result from e.g., a time-based attack where malicious functionality does not trigger until a certain amount of time has elapsed. The replay application security profile 590 may provide a baseline for the expected behavior of the application 426. If the dynamic analysis pipeline 515 identifies any significant deviations (as discussed in further detail herein) in the live (installed) instance of the application 426 from the version of the application 426 on which the replay application security profile 590 is based, it may request the provider account 310 to retest the application 426 for reprofiling (e.g., as determined by the terms of an applicable service level agreement (SLA)).

The dynamic analysis pipeline 515 may continuously generate production application security profiles (via the profile generator 510) for installed instances of the application 426 at intervals and compare them to the replay application security profile 590 to identify changes in public endpoints, code paths, UDFs, egress endpoints and ingress endpoints etc. The dynamic analysis pipeline 515 (via the profile generator 510) may generate production application security profiles in the same way as the replay application security profile 590, but based on live application behavior information (i.e., application behavior information generated by a live (installed) instance of the application 426).

In some embodiments, the dynamic analysis pipeline 515 may limit the number of live instances of application 426 to consider for production profiling to any appropriate number e.g., ten random application instances from different consumer accounts. In some embodiments, where multiple different applications are listed and being utilized in consumer accounts, the dynamic analysis pipeline 515 may prioritize applications with a higher number of installations. In some embodiments, the dynamic analysis pipeline 515 may also prioritize applications that do not currently have a production application security profile for any of their installed instances over applications that do currently have a production application security profile for any of their installed instances to avoid certain applications being overlooked.

Referring to FIG. 5E, once an installed instance of application 426 is selected, the dynamic analysis pipeline 515 may call the profile generator 510 to generate a production application security profile 595 for the installed instance of application 426. The profile generator 510 may generate the production application security profile 595 based on live application behavior information generated by the installed instance of application 426 while executing. The dynamic analysis pipeline 515 may compare deviations between the production application security profile 595 and the replay application security profile 590. For an application that is currently live in one or more consumer accounts (e.g., application 426), significant deviations in the production application security profile 595 from the replay application security profile 590 may indicate that there is potentially a discovery of new functionality that was not observed during the replay profiling or the provider profiling. New functionality in the application 426 can take a number of different forms. Some examples are:
New process creation—new processes are identified from the packet filter monitoring tool 560 logs and correspond to changes to the processes and/or their arguments as captured in the replay application security profile 590. Any changes in either the process or the arguments are considered significant deviations if the threshold number of new process creation deviations (which may be set to any appropriate number e.g., three deviations) has been exceeded. Examples of new process creation may include a new binary name or a change in command line arguments.
New executable file creation—new file actions may be identified from the packet filter monitoring tool 560 logs. Any file created will have an action “FILE_CREATE.” A file is determined to be executable based on its extension (e.g., .sh, .py, .jar, .bin). Any executable file creation not indicated in the replay application security profile 590 may be considered a significant deviation if the threshold number of file creation deviations (which may be set to any appropriate number e.g., three deviations) has been exceeded.
New ingress to process creation flow not seen before—it is not possible to directly tie processes to ingress requests because the common link, which is the port, differs between the upstream host in the ingress logs and the application port where the process starts. Therefore, the best approach is to individually identify new ingress paths in the ingress logs and check if the endpoint process spawns a new subprocess. For example, if an endpoint process spawns a new ingress path and a new process with a new binary.
New process to egress endpoint mapping—the packet filter monitoring tool 560 may generate process connect logs that contain information such as which process created a network connection, information about the source and destination of the connection (e.g., URL if available, source and destination ports and IP addresses, etc.). Similarly, the egress logs contain the source and destination port and IP addresses. Using these process connect and egress logs, the dynamic analysis pipeline 515 may check if any new process (i.e., process not listed in the replay application security profile 590) is sending new egress requests or if a new process is being executed which sends a new egress request (ip+port).
New ingress paths in the ingress logs—if a new ingress path is discovered in the ingress logs, the dynamic analysis pipeline 515 may consider it a significant deviation if the threshold number of new ingress path deviations (which may be set to any appropriate number e.g., one deviation) has been exceeded. For path parameters, the dynamic analysis pipeline 515 may flag any new paths discovered. For query parameters, the dynamic analysis pipeline 515 may flag any query parameters that do not exist in the replay application security profile 590.

If a significant deviation is detected, the dynamic analysis pipeline 515 update an application security data persistence object (not shown) of the deployment 305 to indicate that a significant deviation was detected in the application instance and that a new profile is required. The dynamic analysis pipeline 515 may also update the application security data persistence object to indicate the expected application security profile changes as well. The provider account 310 may be expected to retest this particular installation of the application 426 so that a new provider application security profile and thus a new replay application security profile may be generated (referred to herein as reprofiling). The native applications framework 475 may also take one or more mitigation actions until the application 426 is reprofiled. For example, the native applications framework 475 may immediately suspend/disable the instance of the application 426 depending on the nature of the deviation. In another example, if the application 426 is not reprofiled within a threshold amount of time, the native applications framework 475 may forcefully disable/uninstall all instances of the application 426 from consumer accounts and delist the application 426 from the data exchange.

As can be seen, embodiments of the present disclosure address the risks of sharing applications implemented using containers (as discussed hereinabove) by generating application security profiles at various stages during the submission and vetting of an application for sharing on a data exchange. These application security profiles allow for applications to be installed and run with expected and synthesized inputs to trigger maximum application functionality so their runtime behavior can be properly analyzed prior to allowing such applications to be listed on the data exchange. Embodiments of the present disclosure also continuously monitor application behavior information from installed applications to identify deviations/anomalies from expected behavior (as determined by replay application security profiles) seen during live execution of the application.

FIG. 6 is a flow diagram of a method 600 for dynamically analyzing applications to be shared on a data exchange, in accordance with some embodiments of the present disclosure. Method 600 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the method 600 may be performed by a processing device 305A of cloud deployment 305 (illustrated in FIGS. 4 and 5A-5E).

Referring also to FIG. 5C, in some embodiments the provider account 310 may set up and test the application 426 in their own dedicated testing environment (provider testing account 311 as shown in FIG. 5C) using application testing scripts to e.g., run service functions and call external endpoints as is well known.

At block 605, the dynamic analysis pipeline 515 (via the profile generator 510) may obtain application behavior information of the application 426. More specifically, while the application 426 is being tested by the provider testing account 311 (also referred to herein as provider testing), the analysis tool 555 may be configured as a proxy before the ingress endpoints of the application 426 so that it can automatically capture the requests/responses (as well as their paths and payloads) for each ingress endpoint. In addition, the packet filter monitoring tool 560 may generate packet filter monitoring logs that detail system calls made by the container 427 while the application 426 is being provider tested. The system calls made by the container 427 may indicate processes run by the application 426, processes listening in the application 426 and file actions performed by the application 426. The application behavior information obtained by the analysis tool 555 and the packet filter monitoring tool 560 may be provided to the profile generator 510.

Further, while the application 426 is being provider tested, the profile generator 510 may obtain information about egress hosts (e.g., the web endpoints (and their URLs)) and ports the application 426 connects to by analyzing the application manifest (i.e., the manifest file 470 illustrated in FIG. 4) as well as the network rules and enterprise application integration (EAI—not shown) used by the application 426. Any queries run by the application 426 as part of the provider testing and any permissions required for the application 426 during the testing may be stored in an account query history database (not shown) of the provider testing account 311 and/or the application manifest. Thus, the profile generator 510 may obtain information about the queries run by the application 426 and any permissions required for the application 426 during the provider testing from the account query history database of the provider testing account 311 and/or the application manifest. The profile generator 510 may obtain information about the UDFs and stored procedures included in the application 426 from the application manifest and/or the account query history database of the provider testing account 311. The profile generator 510 may obtain each aspect of the application behavior information of the application 426 as discussed hereinabove and at block 610, may generate a provider application security profile 511 based thereon (also referred to herein as provider profiling). Provider testing allows for automated information gathering and no manual work is required from providers to provide the information. In addition, providers can reuse existing test cases and infrastructure. Provider testing also means that applications submitted for sharing will be tested before listing on the data exchange, thereby reducing the chances of a malicious application being listed on the data exchange. Further, provider testing enables easy manifest enforcement as tested URLs can be added to a manifest automatically (and should be the only URLs and entry points allowed in an application).

The dynamic analysis pipeline 515 may then scan the provider application security profile 511 using the analysis tool 555, the packet filter monitoring tool 560 and the scanning tool 565 as well as monitor changes made to the provider testing account 311 by the application 426 to determine if any of the application behavior information obtained during the provider testing indicates malicious behavior (i.e., malware/malicious code etc.), as discussed in further detail with respect to FIG. 5D. If any malicious behavior is detected, the application 426 is rejected. If no malicious behavior is detected, the application 426 may be subjected to dynamic analysis by the dynamic analysis pipeline 515 as discussed in further detail with respect to FIG. 5D. Dynamic analysis is important not only because of the limitations of static analysis (discussed hereinabove), but also because providers may not always perform complete/thorough testing and/or may not have the capability to test for all types of malicious behavior. This is further compounded by the fact that providers usually utilize test data when performing provider testing, not actual data. As a result, the provider application security profile 511 generated based on the provider testing may not provide a complete picture of the application 426 and all of its components and behaviors.

Referring also to FIG. 5D, the native applications framework 475 may install the application 426 in the testing account 530A using the application package 410. For the application 426 to properly function, it needs to be configured with account level privileges or resources like EAIs, compute pools and warehouses, etc. The native applications framework 475 may utilize a post install script (not shown) to automatically configure privileges and resources needed by the application 426. In some embodiments, the post install script may be part of the manifest file 470 (e.g., listed as one of the artifacts 436). Thus, the native applications framework 475 may first install the application 426 in the test account 530A and then configure it by running the post install script.

The dynamic analysis pipeline 515 may generate the execution script 550 based on the UDFs and stored procedures created in the test account 530A as part of the installation of the application 426 as well as expected inputs defined by the application behavior information in the provider application security profile 511. For example, the dynamic analysis pipeline 515 may define in the execution script 550, expected inputs for the application 426 based on queries run by the application 426 (inputs to UDFs/stored procedures) as well as requests/responses (as well as their paths and payloads) for each ingress endpoint of the application 426. The execution script 550 may also receive synthesized inputs to provide to the application 426 as part of the dynamic analysis as discussed in further detail herein.

The execution script 550 may also validate that the provider application security profile 511 indicates input for all of the UDFs/stored procedures that it lists and that none of the inputs return an error (i.e., that there are no UDFs or stored procedures included in the application 426 that are not listed in the application manifest). If the execution script 550 identifies particular UDFs/stored procedures in the provider application security profile 511 that are not listed in the application manifest, it may reject the application 426 and return it to the provider account 310 for retesting to generate a new provider application security profile that identifies the particular UDFs/stored procedures and provides inputs for the particular UDFs/stored procedures.

Once the application 426 is installed and running in the test account 530A and all the UDFs and stored procedures listed in the provider application security profile 511 are validated, the automation code 570 may extract the base URLs for any public endpoints from the application 426. Once the base URLs for any public endpoints of the application 426 are extracted, the execution script 550 may trigger dynamic analysis of the application 426 (also referred to herein as replay testing). The dynamic analysis may focus on two types of ingress to the application 426: web endpoints and UDFs/stored procedures.

With respect to web endpoints, the analysis tool 555 may utilize its crawlers and analyze web applications running on the public endpoints as well as analyze public facing web services. The automation code 570 may generate a replay file 580 (e.g., an HTTP archive file) including the ingress endpoint request payloads from the provider application security profile 511 and provide the replay file 580 to the analysis tool 555.

At block 615, the analysis tool 555 may generate variations of the ingress endpoint request payloads and (based on instructions from the automation code 570) may send each of the request payload variations as a request to the execution script 550. The automation code 570 may also simulate different user interactions to trigger/discover new UDFs and stored procedures of the application 426 as well as new functionality of existing UDFs and stored procedures of the application 426. The data corresponding to the UDF/stored procedure definitions and various queries used to trigger each of them are included in the provider application security profile 511 (as discussed hereinabove). Using this data, the automation code 570 may generate different variations of the queries for each UDF/stored procedure.

At block 620, the execution script 550 may provide the request payload variations as inputs to the application 426 to attempt to trigger/discover new (i.e., undiscovered) web endpoints as well as attempt to trigger/discover new functionality in these new web endpoints as well as existing web endpoints (essentially simulating user interaction with the application 426 through a browser with a variety of different sets of input). The execution script 550 may also provide each of the query variations as inputs to the application 426 to try and trigger/discover new UDFs and stored procedures, new functionality of the new UDFs and stored procedures and new functionality of existing UDFs and stored procedures of the application 426.

In this way, the dynamic analysis pipeline 515 may generate a sufficient number and variety of inputs to the application 426 to trigger maximum application functionality and thus identify any security vulnerabilities/malicious behavior in the application 426. If new code paths (e.g., UDFs, stored procedures, web end points) that were not listed in the provider application security profile 511 are discovered, the analysis tool 555 may analyze the newly discovered code paths to determine whether the dynamic analysis can continue or not. More specifically, the analysis tool 555 may analyze e.g., a newly discovered UDF to determine whether the inputs of the newly discovered UDF are simple enough that the analysis tool 555 can generate enough sufficiently varied test inputs (e.g., test queries) to thoroughly test the newly discovered UDF. For example, if the inputs to the newly discovered UDF are simple (e.g., integers or strings), the analysis tool 555 may determine that it can generate enough sufficiently varied test inputs to thoroughly test the functionality of the newly discovered UDF. However, if the analysis tool 555 determines that the inputs to the newly discovered UDF are too complex (e.g., JSON or CSV files that require custom input) for it to generate test inputs on its own, then the execution script 550 will fail the application 426 and return it to the provider account 310 for retesting and generation of a new provider application security profile that identifies the newly discovered code paths and provides inputs for the newly discovered code paths.

While the application 426 is being run by the execution script 550 as discussed hereinabove, the profile generator 510 may gather updated application behavior information of the application 426 (in the same manner as the application behavior information was gathered as discussed hereinabove) and at block 625 may generate a replay application security profile 590 based on the updated application behavior information (also referred to herein as replay profiling). At block 630, the automation code 570 may then scan the replay application security profile 590 using the analysis tool 555, the packet filter monitoring tool 560 and the scanning tool 565 to determine if any of the updated application behavior information obtained during testing by the analysis tool 555 indicates malicious behavior.

In addition to monitoring the container 427 through the packet filter monitoring tool 560, the dynamic analysis pipeline 515 will also monitor the changes made to the application testing account 530A by the application 426. The scanning tool 565 may be used to scan the container 427 for any malware that might have been downloaded by the application 426 during the replay testing. If any malicious behavior is detected during the scans performed by the analysis tool 555, the packet filter monitoring tool 560 and the scanning tool 565, the application 426 is rejected. If no malicious behavior is detected, the application 426 may be approved for listing on the data exchange.

Once the application 426 has been listed on the data exchange, the profile generator 510 may periodically generate a production application security profile for an installed instance of the application 426. The dynamic analysis pipeline 515 may compare the production application security profile to the replay application security profile 590 to identify any deviations in the live (installed) instance of the application 426 from the version of the application 426 that was dynamically analyzed to generate the replay application security profile 590. Deviations in live instances of the application 426 can result from e.g., a time-based attack where malicious functionality does not trigger until a certain amount of time has elapsed. The replay application security profile 590 may provide a baseline for the expected behavior of the application 426. If the dynamic analysis pipeline 515 identifies any significant deviations (as discussed in further detail herein) in the live (installed) instance of the application 426 from the version of the application 426 on which the replay application security profile 590 is based, it may request the provider account 310 to retest the application 426 for reprofiling (e.g., as determined by the terms of an applicable service level agreement (SLA)).

Referring to FIG. 5E, once an installed instance of application 426 is selected, the dynamic analysis pipeline 515 may call the profile generator 510 to generate a production application security profile 595 for the installed instance of application 426. The profile generator 510 may generate the production application security profile 595 based on live application behavior information generated by the installed instance of application 426 while executing. The dynamic analysis pipeline 515 may compare deviations between the production application security profile 595 and the replay application security profile 590. For an application that is currently live in one or more consumer accounts (e.g., application 426), significant deviations in the production application security profile 595 from the replay application security profile 590 may indicate that there is potentially a discovery of new functionality that was not observed during the replay profiling or the provider profiling. New functionality in the application 426 can take a number of different forms.

If a significant deviation is detected, the dynamic analysis pipeline 515 update an application security data persistence object (not shown) of the deployment 305 to indicate that a significant deviation was detected in the application instance and that a new profile is required. The dynamic analysis pipeline 515 may also update the application security data persistence object to indicate the expected application security profile changes as well. The provider account 310 may be expected to retest this particular installation of the application 426 so that a new provider application security profile and thus a new replay application security profile may be generated (referred to herein as reprofiling). The native applications framework 475 may also take one or more mitigation actions until the application 426 is reprofiled. For example, the native applications framework 475 may immediately suspend/disable the instance of the application 426 depending on the nature of the deviation. In another example, if the application 426 is not reprofiled within a threshold amount of time, the native applications framework 475 may forcefully disable/uninstall all instances of the application 426 from consumer accounts and delist the application 426 from the data exchange.

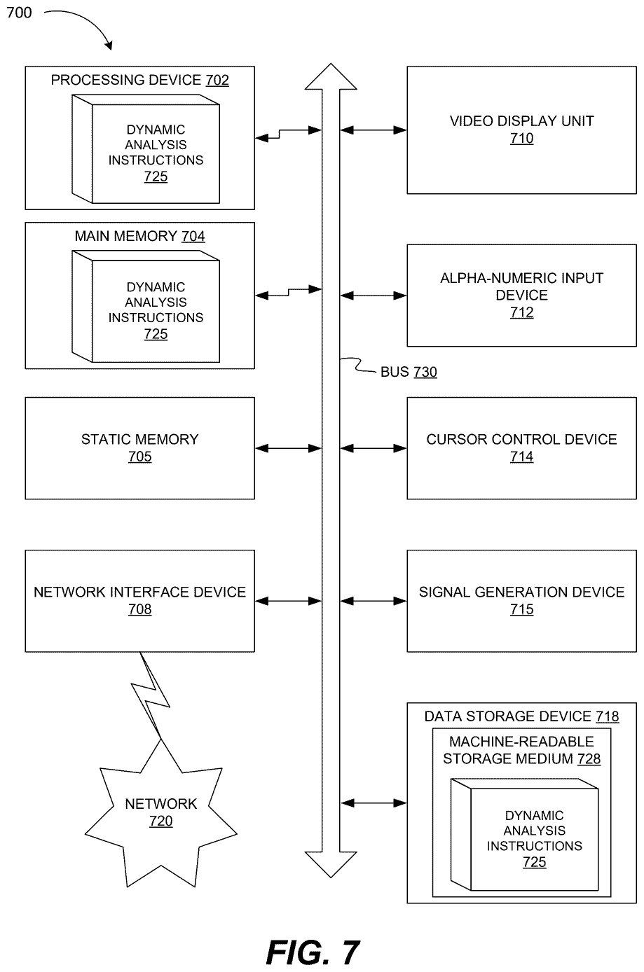

FIG. 7 illustrates a diagrammatic representation of a machine in the example form of a computer system 700 within which a set of instructions is included, the instructions to cause the machine to perform any of the methodologies discussed herein for dynamically analyzing an application to be shared on a data exchange.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 700 may be representative of a server.

The exemplary computer system 700 includes a processing device 702, a main memory 704 (e.g., read-only memory (ROM), flash memory, dynamic random access memory (DRAM), a static memory 705 (e.g., flash memory, static random access memory (SRAM), etc.), and a data storage device 718, which communicate with each other via a bus 730. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computing device 700 may further include a network interface device 708 which may communicate with a network 720. The computing device 700 also may include a video display unit 710 (e.g., a liquid crystal display (LCD) or a cathode ray tube (CRT)), an alpha-numeric input device 712 (e.g., a keyboard), a cursor control device 714 (e.g., a mouse) and an acoustic signal generation device 715 (e.g., a speaker). In one embodiment, video display unit 710, alphanumeric input device 712, and cursor control device 714 may be combined into a single component or device (e.g., an LCD touch screen).

Processing device 702 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 is configured to execute dynamic analysis instructions 725, for performing the operations and steps discussed herein.

The data storage device 718 may include a machine-readable storage medium 728, on which is stored one or more sets of dynamic analysis instructions 725 (e.g., software) embodying any one or more of the methodologies of functions described herein. The dynamic analysis instructions 725 may also reside, completely or at least partially, within the main memory 704 or within the processing device 702 during execution thereof by the computer system 700; the main memory 704 and the processing device 702 also constituting machine-readable storage media. The dynamic analysis instructions 725 may further be transmitted or received over a network 720 via the network interface device 708.

The machine-readable storage medium 728 may also be used to store instructions to perform a method for sharing events generated from a native application being shared by a provider account and executed by a consumer account, as described herein. While the machine-readable storage medium 728 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “obtaining,” “scanning,” “granting,” “determining,” “approving,” “providing,” “designating,” “encoding,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned (including via virtualization) and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams or flow diagrams, and combinations of blocks in the block diagrams or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method comprising:
obtaining application behavior information indicating runtime behavior of an application submitted for sharing in a data exchange;
generating, based on the application behavior information, a first application security profile, the first application security profile comprising inputs to the application;
generating, by a processing device, variations of the inputs to the application;
running the application with the variations of the inputs to generate updated application behavior information;
generating a second application security profile based on the updated application behavior information;
scanning the second application security profile to determine if the application contains any malicious code; and
in response to determining that the application does not contain any malicious code, approving the application for listing on the data exchange.

2. The method of claim 1, further comprising:
obtaining live application behavior information from an instance of the application that is installed in a consumer account of the data exchange;
generating, based on the live application behavior information, a third application security profile;
comparing the third application security profile to the second application security profile to determine if there have been changes in the application that require reprofiling the application; and
in response to determining that there have been changes in the application that require reprofiling the application, performing one or more mitigation actions.

3. The method of claim 1, wherein the application behavior information comprises:
egress hosts and ports the application connects to;
ingress endpoints of the application, paths and payloads of requests to the ingress endpoints of the application, and paths and payloads of responses from the ingress endpoints of the application;
a list of user defined functions (UDFs) and stored procedures included in the application;
queries run by the application;
permissions required by the application; and
packet filter monitoring logs.

4. The method of claim 3, further comprising:
receiving a request for a new version of the application to be submitted for sharing in the data exchange, wherein the request references the first application security profile;
obtaining a list of UDFs and stored procedures included in the new version of the application;
comparing the list of UDFs and stored procedures included in the new version of the application to a list of UDFs and stored procedures included in the second application security profile; and
determining if the new version of the application may be submitted for sharing in the data exchange with the first application security profile based on the comparing.

5. The method of claim 1, further comprising:
testing the application in a provider account to generate the application behavior information.

6. The method of claim 1, wherein the inputs to the application comprise:
queries executed by each UDF and stored procedure of the application; and
paths and payloads of requests to ingress endpoints of the application.

7. The method of claim 6, wherein generating the variations of the inputs to the application comprises:
generating variations of the queries executed by each UDF and stored procedure of the application; and
generating variations of the payloads of requests to the ingress endpoints of the application.

8. A system comprising:
a memory; and
a processing device operatively coupled to the memory, the processing device to:
obtain application behavior information indicating runtime behavior of an application submitted for sharing in a data exchange;
generate, based on the application behavior information, a first application security profile, the first application security profile comprising inputs to the application;
generate variations of the inputs to the application;
run the application with the variations of the inputs to generate updated application behavior information;
generate a second application security profile based on the updated application behavior information;
scan the second application security profile to determine if the application contains any malicious code; and
in response to determining that the application does not contain any malicious code, approve the application for listing on the data exchange.

9. The system of claim 8, wherein the processing device is further to:
obtain live application behavior information from an instance of the application that is installed in a consumer account of the data exchange;
generate, based on the live application behavior information, a third application security profile;
compare the third application security profile to the second application security profile to determine if there have been changes in the application that require reprofiling the application; and
in response to determining that there have been changes in the application that require reprofiling the application, perform one or more mitigation actions.

10. The system of claim 8, wherein the application behavior information comprises:
egress hosts and ports the application connects to;
ingress endpoints of the application, paths and payloads of requests to the ingress endpoints of the application, and paths and payloads of responses from the ingress endpoints of the application;
a list of user defined functions (UDFs) and stored procedures included in the application;
queries run by the application;
permissions required by the application; and
packet filter monitoring logs.

11. The system of claim 10, wherein the processing device is further to:
receive a request for a new version of the application to be submitted for sharing in the data exchange, wherein the request references the first application security profile;
obtain a list of UDFs and stored procedures included in the new version of the application;
compare the list of UDFs and stored procedures included in the new version of the application to a list of UDFs and stored procedures included in the second application security profile; and
determine if the new version of the application may be submitted for sharing in the data exchange with the first application security profile based on the comparing.

12. The system of claim 8, wherein the processing device is further to:
test the application in a provider account to generate the application behavior information.

13. The system of claim 8, wherein the inputs to the application comprise:
queries executed by each UDF and stored procedure of the application; and
paths and payloads of requests to ingress endpoints of the application.

14. The system of claim 13, wherein to generate the variations of the inputs to the application, the processing device is to:
generate variations of the queries executed by each UDF and stored procedure of the application; and
generate variations of the payloads of requests to the ingress endpoints of the application.

15. A non-transitory computer-readable medium having instructions stored thereon which, when executed by a processing device, cause the processing device to:
obtain application behavior information indicating runtime behavior of an application submitted for sharing in a data exchange;
generate, based on the application behavior information, a first application security profile, the first application security profile comprising inputs to the application;
generate, by the processing device, variations of the inputs to the application;
run the application with the variations of the inputs to generate updated application behavior information;
generate a second application security profile based on the updated application behavior information;
scan the second application security profile to determine if the application contains any malicious code; and
in response to determining that the application does not contain any malicious code, approve the application for listing on the data exchange.

16. The non-transitory computer-readable medium of claim 15, wherein the processing device is further to:
obtain live application behavior information from an instance of the application that is installed in a consumer account of the data exchange;
generate, based on the live application behavior information, a third application security profile;
compare the third application security profile to the second application security profile to determine if there have been changes in the application that require reprofiling the application; and
in response to determining that there have been changes in the application that require reprofiling the application, perform one or more mitigation actions.

17. The non-transitory computer-readable medium of claim 15, wherein the application behavior information comprises:
egress hosts and ports the application connects to;
ingress endpoints of the application, paths and payloads of requests to the ingress endpoints of the application, and paths and payloads of responses from the ingress endpoints of the application;
a list of user defined functions (UDFs) and stored procedures included in the application;
queries run by the application;
permissions required by the application; and
packet filter monitoring logs.

18. The non-transitory computer-readable medium of claim 17, wherein the processing device is further to:
receive a request for a new version of the application to be submitted for sharing in the data exchange, wherein the request references the first application security profile;
obtain a list of UDFs and stored procedures included in the new version of the application;
compare the list of UDFs and stored procedures included in the new version of the application to a list of UDFs and stored procedures included in the second application security profile; and
determine if the new version of the application may be submitted for sharing in the data exchange with the first application security profile based on the comparing.

19. The non-transitory computer-readable medium of claim 15, wherein the processing device is further to:
test the application in a provider account to generate the application behavior information.

20. The non-transitory computer-readable medium of claim 15, wherein the inputs to the application comprise:
queries executed by each UDF and stored procedure of the application; and
paths and payloads of requests to ingress endpoints of the application.

21. The non-transitory computer-readable medium of claim 20, wherein to generate the variations of the inputs to the application, the processing device is to:
generate variations of the queries executed by each UDF and stored procedure of the application; and
generate variations of the payloads of requests to the ingress endpoints of the application.
